(19) United States
(12) Patent Application Publication
(10) Pub. No.: US 2007/0090643 A1
(43) Pub. Date: Apr. 26, 2007

(54) Pipe Fitting

(76) Inventor: Chia-Chun Cheng, Chung-Ho City (TW)

Correspondence Address: HDSL, 4331 STEVENS BATTLE LANE, FAIRFAX, VA, 22033, US

(21) Appl. No.: 11/466,737

(22) Filed: Aug. 23, 2006

(30) Foreign Application Priority Data
Oct. 18, 2005 (TW) 094217955

(51) Int. Cl. F16L 27/00

(52) U.S. Cl. 285/190

(57) ABSTRACT

A pipe fitting includes a first pipework with a hollow interior, a casing pipe sheathed onto the first pipework, a stopping portion disposed at an end of the first pipework, a first junction disposed at another end of the first pipework and interconnected to the interior, at least one penetrating hole disposed on the first pipework and interconnected with the interior, and two first washers with an interval apart such that the penetrating hole is situated between the two first washers. The casing pipe has a circular sheath and a cold water junction disposed on an external wall of the circular sheath, and the circular sheath has a circular sheath hole sheathed onto the first pipework, such that the internal wall of the circular sheath is in a close contact with the two first washers and the cold water junction is interconnected with the interior of the first pipework.

### BACKGROUND OF THE INVENTION

1. Field of the Invention

The present invention relates to a pipe fitting, and more particularly to a pipe fitting used in a water-cool circulation system and capable of changing the path of a cooling water pipeline by turning the pipe fitting.

2. Description of Prior Art

At present, many water-cool circulation systems have adopted a water-cool method to dissipate the heat produced by a heat source, which primarily fills a water tank with a cooling liquid such as cold water and uses a cold water pipeline to interconnect the water tank with a hollow cold plate. In the meantime, a pump pumps the cooling liquid from the water tank into the cold plate through the cold water pipeline, and a surface of the cold plate is in contact with a surface of the heat source, so that the cooling liquid can carry away the heat produced by the heat source, so as to maintain an environment with an appropriate temperature.

However, there is a common problem when such water-cool circulation system is used, and the problem resides on that the cold water pipeline cannot be changed or maintained easily. To prevent any leaking of cooling liquid, the water inlet/outlet devices such as the cold water pipeline and cold plate are soldered with the pipe fitting, and thus it is very difficult to change the path of the pipeline or even unable to turn the cold water pipeline in order to change the path of the pipeline. As a result, the overall layout of the water-cool circulation system is limited by the path of the cold water pipeline.

### SUMMARY OF THE INVENTION

In view of the foregoing shortcomings of the prior art, the inventor of the present invention bases on years of experience in the related industry to conduct experiments and modifications, and finally designes a pipe fitting in accordance with the present invention.

Therefore, the present invention is to provide a pipe fitting that can provide an easy way of assembling and disassembling the pipe fitting for repair and maintenance. The invention also provides an easy way of changing the pipe fitting to fit different water flows and changing the path of the cold water pipeline, so that the overall layout of the water-cool circulation system is no longer limited by the path of the pipeline.

The present invention provides a pipe fitting applied to a water-cool circulation system and installed between each water outlet/inlet and a cold water pipeline of the water-cool circulation system. The pipe fitting of the invention comprises a first pipework with a hollow interior, a casing pipe sheathed onto the first pipework, a stopping portion disposed at an end of the first pipework, a first junction disposed at another end of the first pipework and interconnected to the interior of the first pipework, at least one penetrating hole disposed on the first pipework and interconnected with the interior of the first pipework, and two first washers with an interval apart, such that the penetrating hole is situated between the two first washers. The casing pipe has a circular sheath and a cold water junction disposed on an external wall of the circular sheath, and the circular sheath has a circular sheath hole sheathed onto the first pipework, such that the internal wall of the circular sheath is in a close contact with the two first washers and the cold water junction is interconnected with the interior of the first pipework.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a pipe fitting used in a water-cool circulation system in accordance with the present invention;

FIG. 2 is an exploded view of the present invention;

FIG. 3 is a perspective view of the present invention;

FIG. 4 is a cross-sectional view of the present invention;

FIG. 5 is a schematic view of turning a casing pipe to change the path of the pipeline in accordance with the present invention; and

FIG. 6 is an exploded view of a casing pipe and a cool water pipeline in accordance with another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

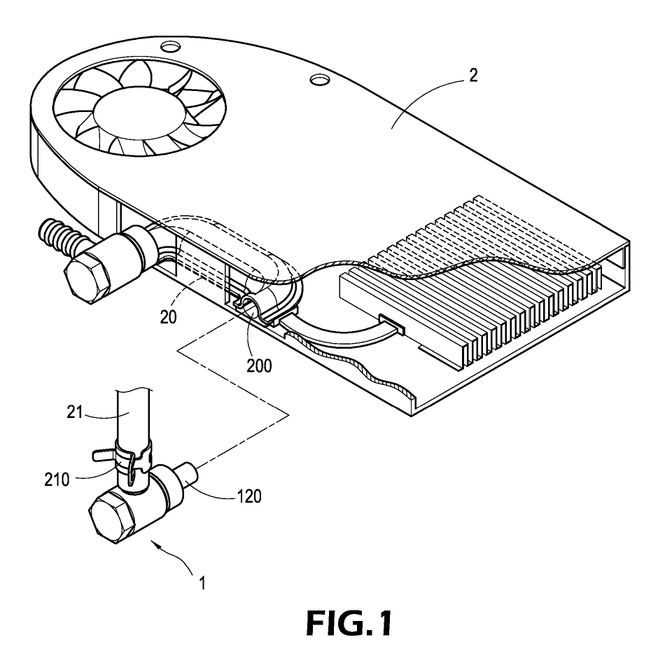

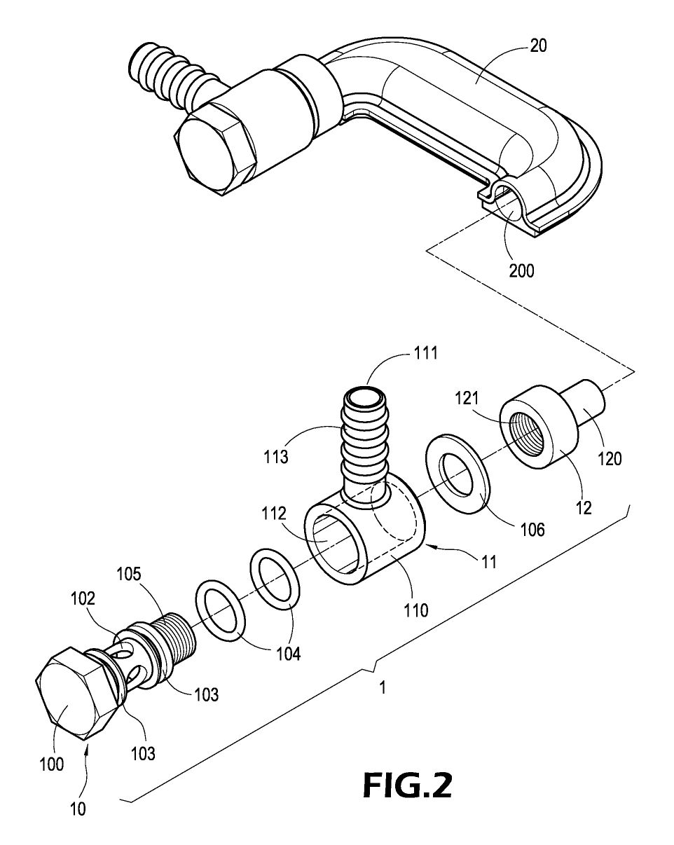

Referring to FIGS. 1 to 3 for a perspective view of a pipe fitting applied to a water-cool circulation system of the present invention and an exploded view and a perspective view of the present invention respectively, the invention provides a pipe fitting applied to a water-cool circulation system 2 and installed between a water outlet/inlet 200 (or other water outlet/inlet) of a cold plate 20 and a cold water pipeline 21 of the water-cool circulation system 2. The pipe fitting 1 comprises a first pipework 10, a casing pipe 11 and a second pipework 12.

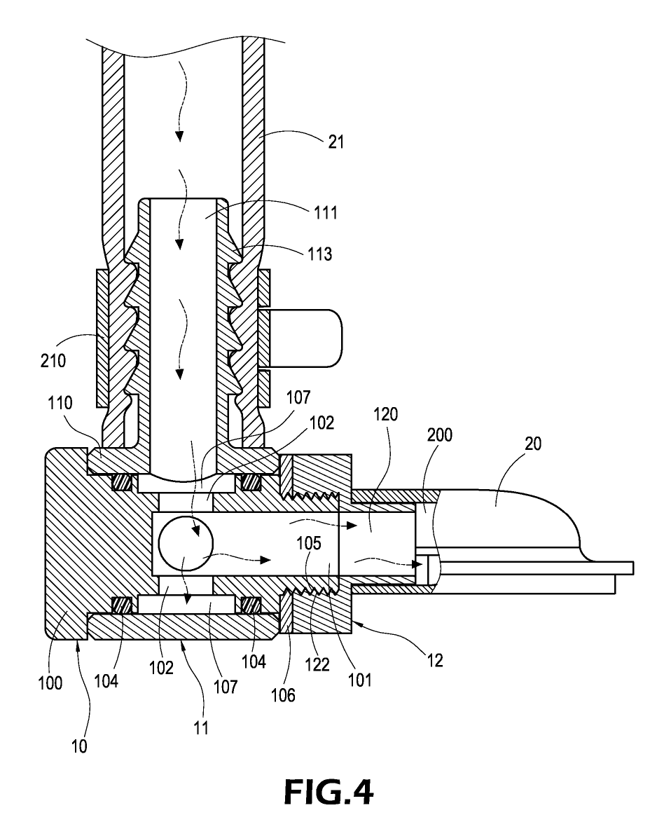

The first pipework 10 is hollow inside that allows a liquid such as cold water to flow through, and one of its ends is sealed, and such end has a stopping portion 100, and the other end of the first pipework 10 has a first junction 101 interconnected to its interior (as shown in FIG. 4). Further, the first pipework 10 has at least one penetrating hole 102 interconnected with the interior of the first pipework, and the first pipework 10 has two circular grooves 103 with an interval apart, such that the penetrating hole 102 is situated between the two circular grooves 103, and the two first washers 104 are embedded separately into the two circular grooves 103.

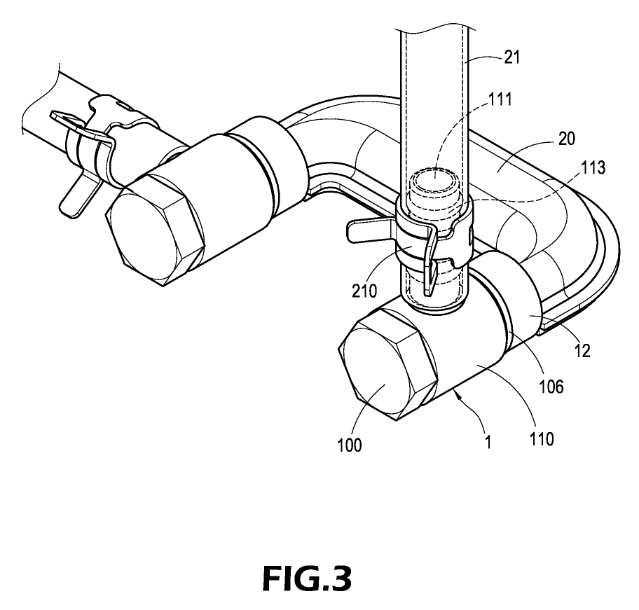

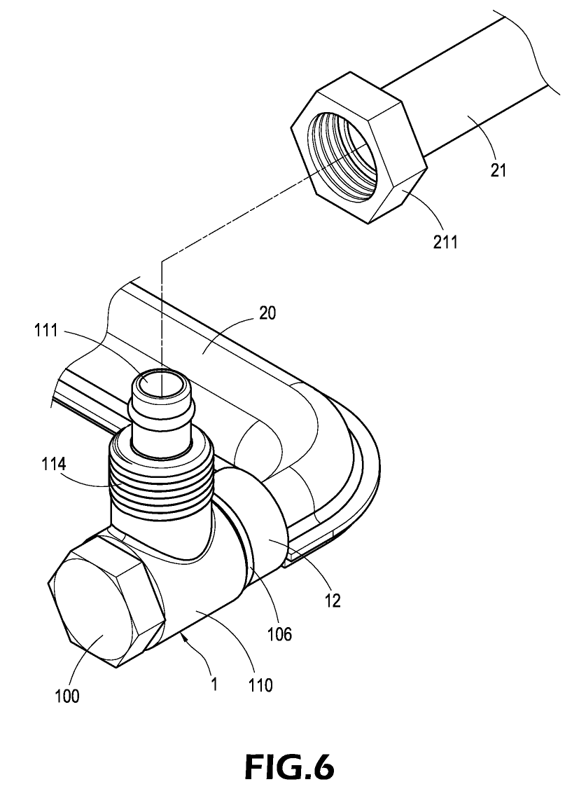

The casing pipe 11 includes a circular sheath 110, and a cold water junction 111 erected from an external wall of the circular sheath 110, wherein the circular sheath 110 has a sheath hole 112 penetrating through both ends of the circular sheath 110 for allowing the first pipework 10 to pass through the sheath hole 112 by its first junction 101, so that an end of the casing pipe 11 presses against the stopping portion 100 of the first pipework 10, and the casing pipe 11 is sheathed onto the first pipework 10, and the internal wall of the casing pipe 11 is forced between the two first washers 104 (refer to FIG. 4 as well) for preventing any leaking. Further, the cold water junction 111 of the casing pipe 11 is interconnected to the sheath hole 112, and thus when the casing pipe 11 is sheathed onto the first pipework 10, the cold water junction 111 can be interconnected to the interior of the first pipework 10 through the sheath hole 112 or even align the cold water junction 111 with the penetrating hole 102 of the first pipework 10 for connecting the cold water junction 111 and the cold water pipeline 21. In this embodiment, the cold water junction 111 has a plurality of circular ribs 113 arranged with an interval from each other and disposed along the axial direction of the cold water junction 111, such that after the cold water pipeline 21 is installed onto the cold water junction 111, a binder 210 (as shown in FIG. 3) is used for a tight connection to achieve the anti-leaking effect. Referring to FIG. 6 for another preferred embodiment of the present invention, the exterior of the cold water junction 111 has an external screw thread 114, and the junction of the cold water pipeline 21 has a screw nut 211 for connecting the external screw thread 114 disposed on the cold water junction 111 by the external screw thread 114 in order to achieve the same effect.

The second pipework 12 is a short pipe for connecting the first pipework 10 with the water outlet/inlet 200 of the cold plate 20. The second pipework 12 has two ends, and one of the ends has a fixing junction 120 (refer to FIG. 4 as well), and the other end has a second junction 121, and the fixing junction 120 and the second junction 121 are interconnected, and the fixing junction 120 can be connected to the water outlet/inlet 200 of the cold plate 20 or further soldered with each other. In this embodiment, the stopping portion 100 of the first pipework 10 is a hexagonal bolt, and the external side of the first junction 101 has an external screw thread 105, and the internal side of the second junction 121 of the second pipework 12 has an internal screw thread 122 (as shown in FIG. 4), such that the stopping portion 100 can be turned clockwise or counterclockwise, and the external screw thread 105 of the first junction 101 can be secured with the internal screw thread 122 of the second junction 121, and a second washer 106 on the first pipework 10 is forced between the second pipework 12 and the casing pipe 11 to achieve the anti-leaking effect. Therefore, the first and second junctions 101, 121 can be detachably connected with each other. After the first and second pipeworks 10, 12 are taken apart, the casing pipe 11 can be removed from the first pipework 10 to change the pipe fitting 1 to fit different water flows or facilitate its repair and maintenance.

Further, the first junction 101 of the first pipework 10 also can be connected directly to the water outlet/inlet 200 of the cold plate 20, without requiring the connection by the second pipework 12. Of course, the water outlet/inlet 200 of the cold plate 20 must be detachably connected to the first junction 101 to achieve the detachable effect.

With the foregoing structure, the pipe fitting in accordance with the invention can be achieved.

Referring to FIG. 4, cold water will enter into the pipe fitting 1 from the cold water junction 111, if the cold water is pumped into the cold water pipeline 21, and then will enter into the cold plate 20 from the first junction 101 or fixing junction 120. On the other hand, cold water will be discharged from another water outlet/inlet 200 of the cold plate 20 to achieve the heat dissipating effect by the contact with cold water.

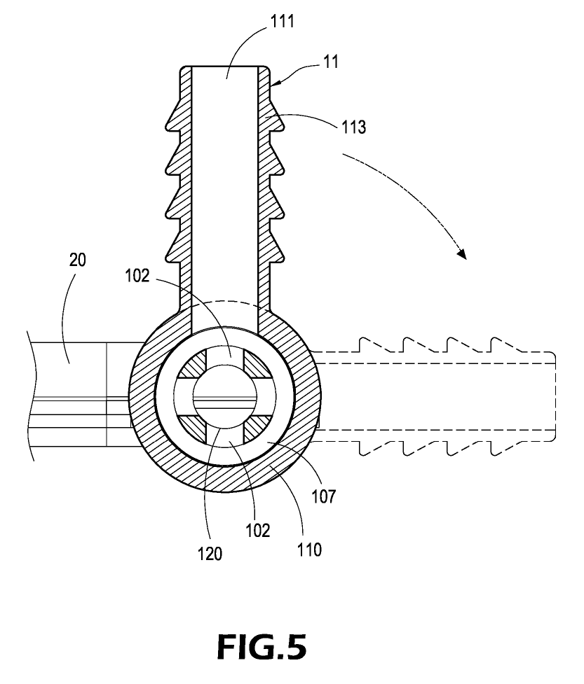

Referring to FIG. 5, the casing pipe 11 can be rotated within 360 degrees on the first pipework 10, and the cold water junction 111 can be turned to other directions in order to change the path of the cold water pipeline 21, since the casing pipe 111 is sheathed onto the first pipework 10 and the sheath hole 112 of the casing pipe 11 is a circular hole. Therefore, the overall layout of the water-cool circulation system 2 is no longer limited to a specific direction of its pipeline. In the meantime, the cold water junction 111 still maintains its interconnection with the interior of the first pipework 10 to facilitate the rotation at the casing pipe 11, and thus a circular channel 107 is formed between the first pipework 10 and the casing pipe 11, and the circular channel 107 is interconnected with the penetrating hole 102 at the position between the cold water junction 111 and the first pipework 10.

In summation of the description above, the present invention herein enhances the performance of the conventional structure and further complies with the patent application requirements and is duly filed for patent application.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A pipe fitting, comprising:
a first pipework, having a hollow interior, a stopping portion at one end of the first pipework, a first junction disposed at the other end of the first pipework and interconnected to the interior, at least one penetrating hole disposed on the first pipework and interconnected to the interior, and two first washers disposed with an interval apart and the penetrating hole being disposed at a position between the two first washers;
a casing pipe, having a circular sheath and a cold water junction disposed on an external wall of the circular sheath, and the circular sheath being sheathed onto the first pipework, such that an internal wall of the circular sheath is in a close contact with the first washer, and the cold water junction is interconnected with the interior of the first pipework; and
a second pipework, having a fixing junction disposed at one end of the second pipework, and a second junction disposed on the other end of the second junction and interconnected with the first junction, and the second junction being detachably coupled to the first junction, and a second washer being forced between the second pipework and the casing pipe.

2. The pipe fitting of claim 1, wherein the stopping portion of the first pipework is a screw bolt.

3. The pipe fitting of claim 1, wherein the first pipework includes two circular grooves with an interval apart, and the penetrating hole is disposed between the two circular grooves for embedding the two first washers into the two circular grooves, respectively.

4. The pipe fitting of claim 1, further comprising a circular channel disposed between the first pipework and the casing pipe and interconnected between the penetrating hole of the first pipework and the cold water junction.

5. The pipe fitting of claim 1, wherein the penetrating hole of the first pipework corresponds to the cold water junction of the casing pipe.

6. The pipe fitting of claim 1, wherein the first junction of the first pipework has an external screw thread, and the second junction of the second pipework has a corresponding internal screw thread, and the external screw thread and the internal screw thread are screwed with each other.

7. The pipe fitting of claim 1, wherein the circular sheath of the casing pipe has a sheath hole penetrating through both ends of the circular sheath for sheathing the circular sheath onto the first pipework.

8. The pipe fitting of claim 7, wherein the sheath hole is a circular hole.

9. The pipe fitting of claim 1, wherein the second washer is sheathed onto the first pipework.

10. A pipe fitting, comprising:
a first pipework, having a hollow interior, a stopping portion at one end of the first pipework, a first junction disposed at the other end of the first pipework and interconnected to the interior, at least one penetrating hole disposed on the first pipework and interconnected to the interior, and two first washers disposed with an interval apart and the penetrating hole being disposed at a position between the two first washers; and
a casing pipe, having a circular sheath and a cold water junction disposed on an external wall of the circular sheath, and the circular sheath being sheathed onto the first pipework, such that an internal wall of the circular sheath is in a close contact with the first washer, and the cold water junction being interconnected with the interior of the first pipework.

11. The pipe fitting of claim 10, wherein the stopping portion of the first pipework is a screw bolt.

12. The pipe fitting of claim 10, wherein the first pipework includes two circular grooves with an interval apart, and the penetrating hole is disposed between the two circular grooves for embedding the two first washers into the two circular grooves.

13. The pipe fitting of claim 10, further comprising a circular channel disposed between the first pipework and the casing pipe and interconnected between the penetrating hole of the first pipework and the cold water junction.

14. The pipe fitting of claim 10, wherein the penetrating hole of the first pipework corresponds to the cold water junction of the casing pipe.
